(19) United States
(12) Patent Application Publication
(10) Pub. No.: US 2005/0207870 A1
(43) Pub. Date: Sep. 22, 2005

(54) Conveyance device for the pressing of glued spines of book blocks for books

(76) Inventor: Hans Muller, Lauda-Konigshofen (DE)

Correspondence Address: Friedrich Kueffner;Suite 910, 317 Madison Avenue, New York, NY, 10017, US

(21) Appl. No.: 11/072,697

(22) Filed: Mar. 4, 2005

(30) Foreign Application Priority Data
Mar. 5, 2004 (EP) 04405131.6-2305

(51) Int. Cl. B42C 9/00

(52) U.S. Cl. 412/33; 270/58.08

(57) ABSTRACT

A conveyance device for the pressing of glued spines of a book block for books, in which the book blocks, with their spines directed downward, pass through a pressing section that reduces the spine swell. The book blocks, gripped between working pieces of revolving traction elements, pass through the pressing section, which acts on the sidepieces of the book spine.

### BACKGROUND OF THE INVENTION

1. Field of the Invention

The present invention relates to a conveyance device for the pressing of glued spines of book blocks for books, which, with their spines directed downward, pass through a pressing section of a conveying line that acts on the sidepieces of the spine of the book block.

2. Description of the Related Art

According to the pamphlet “Sigloch Drying Conveying Lines TF/TFD” of the company Sigloch Maschinenbau GmbH, Künzelsau, DE, after the spines of the book blocks have been glued, the book blocks are guided, standing on their spines, through several blown air zones, where they are subjected to a drying process. As is well known, this drying conveying line is about 60 m long and ends at a book block press, for example, “Fully Automatic Book Block Press NH/DNH” of the company Sigloch Maschinenbau GmbH, Künzelsau, DE, as shown and described in a pamphlet 4/86.

Instead of the book spine gluing machine, a back-gluing machine could also be provided for bound books passing through (perfect-bound or thread-stitched). The book block press downstream of the drying conveying line operates in time with the machine when the book block is stationary, i.e., the book blocks are fed to the book block press spaced apart. The book blocks standing vertically on the glued spine are fanned out as they are conveyed to the pressing station due to their clearance from the lateral guide walls, which can result in deformation of the book block spine on the long passage to the book block press. This is found to be a disadvantage during the final pressing in the book block press, because the change in shape of the book block spine that occurs during conveyance is reinforced by the book block press.

### SUMMARY OF THE INVENTION

The object of the invention is to create a device of the aforementioned type, with which high shape stability of the spine can be achieved with little expense and without loss of quality, and which can be connected at any desired place along the conveyance path.

In accordance with the invention, this object is achieved by designing the pressing section with two working pieces of revolving traction elements, which working pieces are spaced apart transverse to the conveying direction (F) of the book block and convey the book blocks between them, and with several pairs of pressing rollers, which act laterally on the sidepieces of the book block spines, are arranged in succession in the conveying direction (F) of the book blocks (13), and rotate about vertical axes.

This makes it possible, after the book block spine has been glued, to continue the further processing of the book block under favorable conditions.

It has been found to be effective if the conveyance device has an expanded entrance, which is followed by a continuous transition at the inlet into the pressing section, thereby eliminating disturbances of the operational process and damage to the book blocks. The entrance steadily tapers in the conveying direction due to conical lateral surfaces.

The pressing section, in which the spine swell of a glued book block spine, or possibly of a book block spine that has been provided with a reinforcing strip, is reduced by pressing on the sidepieces of the book spine, is advantageously formed by at least one pair of pressing rollers that act laterally on the sidepieces of the book block spine and rotate about vertical axes. The pressing rollers produce a relatively high pressure on the continuously passing book blocks in a rolling-off process without leaving any marks on the book block.

These pressing rollers are preferably supported by means that allow them to rotate freely and are driven by the book blocks gripped between the working pieces of the revolving traction elements.

Several pairs of pressing rollers can be arranged in succession along the conveyance path of the book blocks, so that the spines of the book blocks are repeatedly pressed; several pairs of pressing rollers with a moderate pressing pressure place less stress on the book blocks but all together produce the same desired reduction of the spine swell as one pair of pressing rollers that exerts a higher pressing pressure. Several pairs of pressing rollers can exert a more uniform pressing pressure on the book blocks than one pair of pressing rollers. Optimization can also be achieved by a favorable relationship among the contact pressure, the number of pairs of pressing rollers, and the diameter of the pressing rollers. It is advantageous if at least one pressing roller of each pair of pressing rollers can be adjusted transversely to the conveying direction F of the book blocks to change the distance between the rollers. It has been found to be advantageous if the adjustable pressing rollers of several pairs of pressing rollers are designed to be adjusted either individually or jointly, so that the pressing operation can be extensively adapted to optimize the quality of the book blocks.

A simple refinement can be realized if at least the jointly adjustable pressing rollers of several pairs of pressing rollers are supported on a pressing roller carrier.

To adjust the pressing roller carrier, it can be effective to connect it with a spindle drive, which allows precise adjustment of the pressing rollers.

The pressing rollers positioned opposite the adjustable pressing rollers are preferably flexibly supported against the facing sidepiece of a book block spine.

It is advantageous if the guide strip, which is designed for making the adjustment, and the adjustable support beam of the pressing rollers are arranged on the same side of the conveyance path of the book blocks, since this simplifies the adjustment of the guide device and of the pressing rollers of the pressing section.

The spine of the book block can be guided on a support in the pressing section, so that it doesn't buckle during pressing. The chain carrier preferably extends at least approximately the entire length of the pressing section, so that a stable conveyance path for the book blocks is produced.

It has been found to be advantageous if the entrance or feed end of a guide device is arranged downstream (in conveying direction F) of the front end of the book block conveyance path formed by the working pieces of the traction elements, so that optimum entry of the book block into the pressing section is guaranteed.

It is advantageous for a feeding device, which conveys the glued book block standing on its spine, to be placed at the front end of the conveyance path.

The feeding device can have an upstream acceleration section, by which the book blocks, which are fed spaced apart, arrive in the pressing section lined up and make optimum use of the pressing section.

The various features of novelty, which characterize the invention, are pointed out with particularity in the claims annexed to and forming part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWING

In the drawing:

FIG. 1 shows a three-dimensional. representation of the device of the invention.

FIG. 2 shows a cross section of the device in FIG. 1.

### DETAILED DESCRIPTION OF THE INVENTION

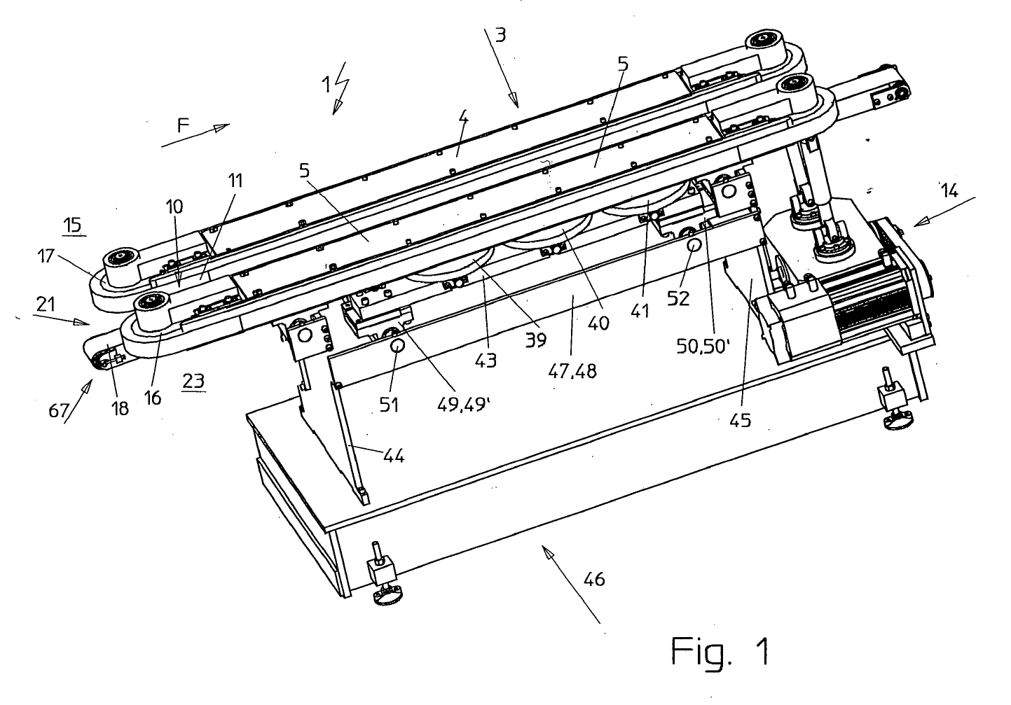

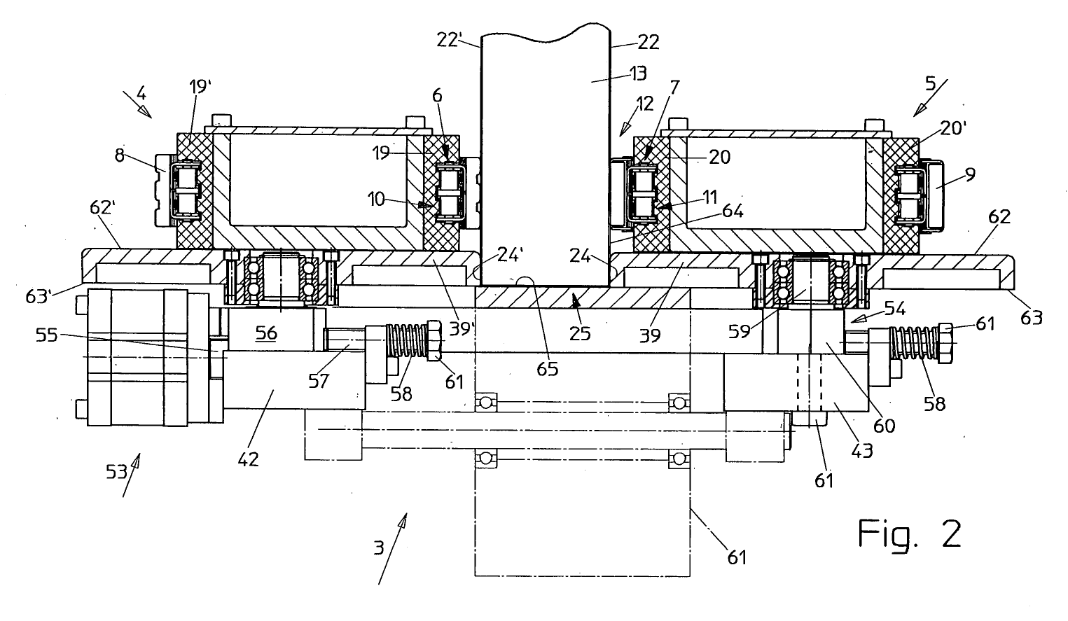

FIG. 1 shows a three-dimensional representation of a conveyance device 1 for the pressing of glued spines 25 of book blocks 13. With their spines 25 directed downward, the book blocks 13 pass through a pressing section 3 of a conveying line in conveying direction F (for example, after drying). In the pressing section 3, the sidepieces 24, 24′ of the spine 25 of the book block 13 are compressed to a smaller spine swell. FIG. 2, which shows a cross section of the pressing section 3, illustrates traction elements 6, 7 revolving on a chain carrier 4, 5. Clamping elements 8, 9 are mounted side by side on the traction elements 6, 7, as described and illustrated, for example, in European Patent Application 01/810,911. Between the traction elements 6, 7, their working pieces 10, 11 form a conveyance path 12, on which the book blocks 13 are conveyed in succession in conveying direction F. The chain carrier 4, 5 has a box-like cross-sectional shape, and the ends are designed to support deflection pulleys. Two adjacent deflection pulleys, one on each chain carrier 4, 5, are driven by a geared motor 14.

The feed end 15 of the conveyance device 1 is extended relative to the conveyance path 12 and narrows continually in conveying direction F into the conveyance path 12, which is formed by two parallel working pieces 10, 11. The feed end 15 of the conveyance path 12 consists of two deflection pulleys 16, 17 (see FIG. 1) of the traction elements 6, 7 and serves to feed the glued book blocks 13, which are conveyed, standing on their spines, on a feed conveyor belt 18. The chain carrier 4, 5 has chain guide strips 19, 19′; 20, 20′ made of wear-resistant plastic, in which the traction element 6, 7, which is formed as a chain, is guided laterally and vertically in a positive-locking way. The book blocks 13 approaching on the feed conveyor belt 18 are picked up by the working pieces 10, 11 of the traction elements 6, 7 on their flat sides 22, 22′ and leave the feed conveyor belt, gripped between the working pieces 10, 11 and hanging out at the bottom, before re aching or being picked up by the pressing section 3. The spines 25 of the book blocks 13 could be conveyed, sliding with their sidepieces 24, 24′, over a conically narrowing entrance section of the conveyance path 12 in a guide device 21 formed by two laterally spaced guide strips.

The conveyance path 12 is designed to be adjusted transversely to the conveying direction F according to the varying thickness of the book blocks 13 passing through.

The pressing section 3, which exerts a conveying action, has three pairs of pressing rollers 39, 39′; 40, 40′; 41, 41′ that oppose each other on the conveyance path 12 and are preferably supported in such a way that they can rotate freely about vertical axes. The book blocks 13 gripped between the working pieces 10, 11 are continuously conveyed into the pressing section 3, where their sidepieces 24, 24′ are engaged by the pressing rollers 39, 39′; 40, 40′; 41, 41′ and pressed as they pass through. In this connection, at least one row of the pressing rollers 39, 39′; 40, 40′; 41, 41′ aligned in the conveying direction F of the book blocks 13 is designed to be adjusted laterally or transversely to the conveying direction. For this purpose, each row of pressing rollers has a pressing roller carrier 42, 43, which is joined with vertical supports 44, 45 (see FIG. 1) of a machine frame 46. The vertical supports 44, 45 are provided for supporting the chain carriers 4, 5, which could also be used for mounting the pressing roller carriers 42, 43. So that the pressing roller carriers 42, 43 can be adjusted transversely to the conveying direction F independently of the chain carriers 4, 5, they are mounted on two longitudinal strips 47 that join the vertical supports 44, 45 on both sides of the device 1. This is accomplished indirectly by two bearing blocks 49, 49′; 50, 50′ arranged in pairs between them, of which one each can be adjusted on a guide rod 51, 52 passing through the bearing blocks 49, 49′; 50, 50′. This adjustment can be made transversely to the conveying direction F of the book blocks by means of a spindle drive (not shown). The individual pressing rollers 39, 39′; 40, 40′; 41, 41′ are designed with their own adjusting devices 53, 53′, 53′′; 54, 54′, 54′′, of which one each is shown in FIG. 2. Adjusting device 53 is a pneumatically operated piston-cylinder unit, whose piston 55 acts on a swiveling lever 56 that has a pressing roller 39′ at its free end, whose swiveling position at the other end can be determined by an adjusting screw 56 secured by a compression spring 58.

Naturally, this design offers the possibility of adjusting the pressing rollers 39′, 40′, 41′ of this row jointly or individually. The opposite row provides the possibility of manual adjustment of the individual pressing rollers 39, 40, 41; in this possibility, a hexagonal part 60 that is connected coaxially with a journal 59 of a pressing roller 39, 40, 41 is connected off-center with a screw 61 that penetrates the pressing roller carrier 43. The locking of the hexagonal part 60 is in turn accomplished by advancing a screw 61 whose turning is resisted by a spring 58. Further details and alternative designs of the adjusting devices 53, 54 are not described, since they are not an essential part of the object described here. The pressing rollers 39, 39′; 40, 40′; 41, 41′ can be flexibly supported not only by the pressing roller carrier or carriers 42, 43 but also in rows. As FIG. 2 shows, the pressing rollers 39, 39′; 40, 40′; 41, 41′ are formed rectangularly at the transition of the circumference to the front face; they could be rounded or designed without sharp edges at least at the transition of the circumference and the end face turned away from the spine of the book block 13. In the processing of fine paper grades, gentle and protective pressing of the spines 25 of the book blocks could be achieved with unsharp edges or with a tapering conical shape on the circumference of the pressing rollers 39, 39!; 40; 40′; 41, 41′.

In this connection, it would also be possible to carry out a replacement of pressing rollers that are differently designed at the transition from the circumference to the end faces of the pressing rollers.

The hang-out of a book block 13 reaches at least approximately the lower circumferential edge of a pressing roller 39, 39′; 40, 40′; 41, 41′. During the pressing of a relatively high spine swell of a book block 13, it can be effective, as shown in FIG. 2, if the spine 25 of the book block is guided on a support. This support 65 is approximately coplanar with a support of the spine 25 of the book block 13 in a conveying or drying section. The support 65 could consist of several freely rotating drums 66 arranged in succession in conveying direction F or a stationary support surface, for example, a strip.

FIG. 1 shows that the chain carriers 4, 5 are at least approximately as long as the pressing section 3. This guarantees a continuous book block 13 processing operation. The feed end 15 is downstream (in the conveying direction F of the book blocks) of the front end of the conveyance path 12 formed by the working pieces 10, 11 of the traction elements 6, 7, and the entrance is wider than the separation between the opposing working pieces 10, 11 of the traction elements 6, 7. This allows trouble-free entrance of the book blocks 13 into the conveyance path through the entrance section 23. A feeding device 67, which feeds the book blocks 13 to the conveyance device, is connected at the front end of the conveyance path 12.

The invention is not limited by the embodiments described above which are presented as examples only but can be modified in various ways within the scope of the protection defined by the appended patent claims.

1. A conveyance device for pressing of glued spines of book blocks for books, which, with the spines directed downward, pass in a conveying direction through a pressing section of a conveying line, which pressing section acts on sidepieces of the spine of the book block, wherein the pressing section is comprised of two working pieces of revolving traction elements, wherein the working pieces are spaced apart transverse to the conveying direction of the book block and convey the book blocks between them, and several pairs of pressing rollers acting laterally on the sidepieces of the book block spines, wherein the pressing rollers are arranged in succession in the conveying direction of the book blocks, and rotate about vertical axes.

2. The device in accordance with claim 1, wherein the pressing rollers of a pair of pressing rollers are supported so as to be freely rotatable.

3. The device in accordance with claim 1, wherein at least one pressing roller of each pair of pressing rollers is adjustable transversely of the conveying direction of the book blocks (13) to change a lateral distance between the rollers.

4. The device in accordance with claims 1, wherein the adjustable pressing rollers of several pairs of pressing rollers are designed to be adjustable individually or jointly.

5. The device in accordance with claim 4, wherein that jointly adjustable pressing rollers of several pairs of pressing rollers are supported on a pressing roller carrier.

6. The device in accordance with claim 5, wherein the pressing roller carrier of the adjustable pressing rollers is connected to a spindle drive.

7. The device in accordance with claims 3, wherein pressing rollers positioned opposite the adjustable pressing rollers are flexibly supported against the sidepiece of a book block spine.

8. The device in accordance with claims 3, wherein rotating edges of a pressing roller that act on a sidepiece of the book block spine are not sharp-edged.

9. The device in accordance with claims 1, wherein the pressing rollers are supported so as to be replacable.

10. The device in accordance with claims 1, wherein the book block is conveyed in the pressing section with its spine standing on a support.

11. The device in accordance with claims 1, wherein the working pieces of the revolving traction elements have at least approximately the same length as the pressing section.

12. The device in accordance with claims 1, wherein a feed end of the pressing section is located downstream of the front end of the conveying line formed by the working pieces of the traction elements.

13. The device in accordance with claims 1, wherein a feeding device is assigned to the front end of the conveying line.

14. The device in accordance with claim 13, wherein the feeding device has an upstream acceleration or deceleration section.

15. The device in accordance with claims 1, wherein comprising a guide device that extends to the sidepieces of the book block and that can be adjusted transversely to the conveying direction arranged upstream of the pressing section.

16. The device in accordance with claims 1, wherein a heatable drying section is arranged upstream of the pressing section.
